(19) United States
(12) Patent Application Publication
(10) Pub. No.: US 2015/0114730 A1
(43) Pub. Date: Apr. 30, 2015

(54) SUSPENSION SYSTEM FOR TRACKED VEHICLES

(71) Applicant: BAE Systems Hägglunds Aktiebolag, Örnsköldsvik (SE)

(72) Inventor: Christer Gulliksson, Ornskoldsvik (SE)

(73) Assignee: BAE Systems Hägglunds Aktiebolag, Örnsköldsvik (SE)

(21) Appl. No.: 14/398,316

(22) PCT Filed: Jun. 18, 2013
(86) PCT No.: PCT/SE2013/050720

§ 371 Date: Oct. 31, 2014

(30) Foreign Application Priority Data
Jun. 27, 2012 (SE) 1250697-8

(51) Int. Cl. B62D 55/108; B60G 3/14

(52) U.S. Cl. CPC B62D 55/1086; B60G 3/14
USPC 180/9.54

(57) ABSTRACT

A suspension system for a tracked vehicle includes support wheels arranged on opposite sides of the vehicle which are rotatably journalled at an outer end of a respective rocker arm, which is pivotably journalled in the side of a vehicle chassis of the vehicle, which rocker arm includes a pivot axle, which extends transversely to the longitudinal extension of the vehicle. A torsion element in the shape of a rubber bushing is rotationally fixed to the pivot axle and which rubber bushing is enclosed by and fixedly connected to an outer bushing sleeve arranged to be fixedly fastened in the side of the vehicle chassis. The pivot axle is pivotably journalled in the vehicle chassis with radial bearings arranged on each side of the rubber bushing. The outer bushing sleeve and a support housing comprises a pivot preventing member.

### BACKGROUND OF THE INVENTION AND PRIOR ART

The present invention relates to a suspension system for a tracked vehicle according to the preamble of claim 1.

In tracked vehicles the support wheels takes up the weight of the vehicle. The support wheels are arranged on opposite sides of the vehicle for contact against the inside of a respective endless drive track, the support wheels being rotatably journalled at an outer end of the respective rocker arm.

The support wheels are resiliently suspended with rocker arms in the chassis of the vehicle by means of a suspension system. Thereby the suspension system supports the entire suspension movement of the rocker arms about a pivot axle extending transversely to the longitudinal extension of the vehicle.

The suspension system is built up of torsion elements in the shape of a rubber bushing which is rotationally fixed to the pivot axle and which rubber bushing is enclosed by and fixedly connected to an outer bushing sleeve arranged to be fixedly fastened in the side of the vehicle chassis.

Document SE 511665 C2 shows a known suspension system comprising a torsion element in the shape of a rubber bushing and in the shape of a torsion bar in metal, which rubber bushing and torsion bar are connected in series in order to simultaneously and together take up torque exerted on the rocker arms.

According to the known suspension system the rubber bushing will however take up the entire weight of the vehicle, which will result in the rocker arm being tilted in the rubber bushing due to bending moment. As a result the rubber material will after a period of time be permanently deformed, which results in it becoming difficult to maintain correct camber angle of the support wheel.

In the known suspension system an anchor ring is also used to fixate the rubber bushing in a support sleeve. The anchor ring is fastened in the support sleeve with a bolt joint, which results in the number of components being part of the suspension system becoming large.

In view of the background above there is a need to further develop a suspension system for tracked vehicles.

### SUMMARY OF THE INVENTION

The object of the present invention is to provide a suspension system for tracked vehicles, which suspension system can be relieved from large side forces due to bending moment.

An additional object of the invention is to provide a suspension system for tracked vehicles, which suspension system maintains correct camber angle of the support wheels.

Yet another object of the present invention is to provide a suspension system for tracked vehicles, which suspension system facilitates to during assembly place a rocker arm in correct position relative to the vehicle.

Yet another object of the present invention is to provide a suspension system for tracked vehicles, which suspension system shows only a few numbers of components.

These objects are achieved with a suspension system for tracked vehicles stated by way of introduction, which is characterized by the features recited in claim 1.

Such a suspension system for tracked vehicles has a pivot axle, which is pivotably journalled in the chassis of the vehicle with a radial bearing arranged on each side of the rubber bushing, such that the rubber bushing takes up only torsional forces. Thereby the rubber bushing will be relieved from large side forces arising due to bending moment, which results in the fact that the pivot axle of the rocker arm and the centre axle of the rubber bushing will remain essentially parallel. Thus it is avoided that the rubber bushing will be tilted relative to the rocker arm. As a result the rubber material will not be permanently deformed, which results in that a correct camber angle of the support wheel may be maintained.

According to an embodiment of the invention the support housing is provided with a pivot preventing means in the shape of a number of circumferential recesses for pivot preventing locking engagement with protrusions in the gable or vice versa. Thereby no separate anchor ring is needed to fixate the rubber bushing. This results in that a separate bolt joint for the anchor ring may be eliminated, which results in that the number of components being part of the suspension system is reduced. The pivot preventing means provides the possibility to place the rocker arm in correct position relative to the vehicle during assembly, which among other affects the height of the vehicle from the ground on which the vehicle rests or travels.

Additional advantages of the invention are apparent from the following detailed description.

### BRIEF DESCRIPTION OF THE DRAWINGS

In the following is described, as an example, a preferred embodiment of the invention with reference to the accompanying drawings, in which:

FIG. 1 shows a side view of a tracked vehicle provided with a suspension system according to the present invention,

FIG. 2 shows a perspective view of a suspension system for a tracked vehicle according to a first embodiment of the present invention,

FIG. 3 shows a side view of how the support housing is fixed in the side of the vehicle chassis by means of the fastening flange of the suspension device according to the present invention,

FIG. 4 shows a perspective view of the suspension device for a tracked vehicle according to the first embodiment of the present invention,

FIG. 5 shows a cross sectional view through the suspension for a tracked vehicle according to the first embodiment of the invention,

FIG. 6 shows a perspective view of the suspension for a tracked vehicle according to a second embodiment of the present invention, and

FIG. 7 shows a perspective view of the suspension for a tracked vehicle according to a third embodiment of the present invention.

### DETAILED DESCRIPTION OF A PREFERRED EMBODIMENT OF THE INVENTION

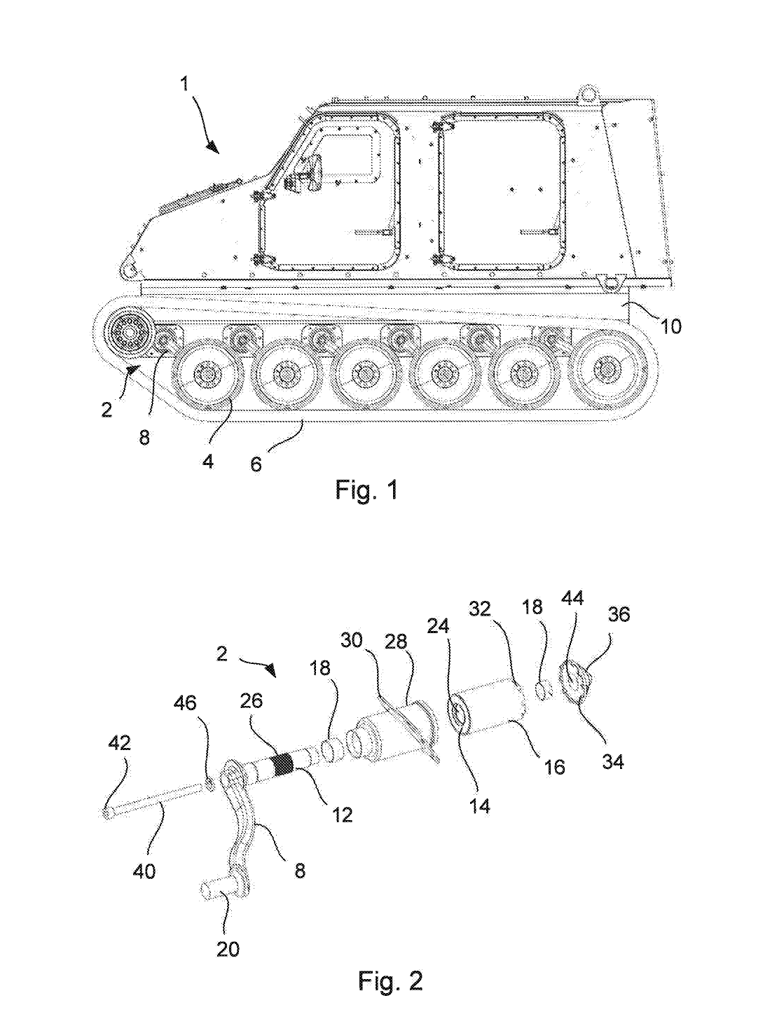

FIG. 1 shows a side view of a tracked vehicle 1 provided with a suspension system 2 according to the present invention. Along opposite sides of the vehicle 1 a number of support wheels 4 are arranged for contact against the inside of a respective endless drive track 6. The support wheels 4 are rotatably journalled at an outer end of the respective rocker arm 8, which at its inner end to a limited extend is pivotably journalled in the side of the vehicle chassis 10.

FIG. 2 shows a perspective view of a suspension system 2 for a tracked vehicle 1 according to a first embodiment of the present invention. For clarifying purpose the components being part of the suspension system have been placed at a distance from each other. The rocker arm 8 comprises a pivot axle 12, which extends transversely to the longitudinal extension of the vehicle 1, wherein a torsion element in the shape of a rubber bushing 14 is rotationally fixed to the pivot axle 12. The rubber bushing 14 is enclosed by and fixedly connected to an outer bushing sleeve 16 arranged to be fixedly fastened in the side of the vehicle chassis 10. The pivot axle 12 is pivotably journalled in the vehicle chassis 10 with radial bearings 18 arranged on each side of the rubber bushing 14. The radial bearings 18 take up side forces, which arise from bending moments acting on the pivot axle 12. Thereby the rubber bushing 14 will take up only torsional forces. Preferably the radial bearings 18 are slide bearings, but it is also possible to design the radial bearings 18 as roller bearings. The rocker arm 8 also has an shaft pivot 20 on which support wheels 22 may be arranged.

The rubber bushing 14 encloses and is fixedly connected to an inner bushing sleeve 24, which is rotationally fixed on the pivot axle 12 with a first splined joint 26. Preferably the rubber bushing 14 is fixedly vulcanized in the outer bushing sleeve 16 and on the inner bushing sleeve 24, which results in that the rubber bushing 14 and the inner and outer bushing sleeves 24, 16 form a coherent unit. The spring and damping properties of the suspension system 2 may be varied by varying the length of the rubber bushing 14 and the material of the rubber bushing 14.

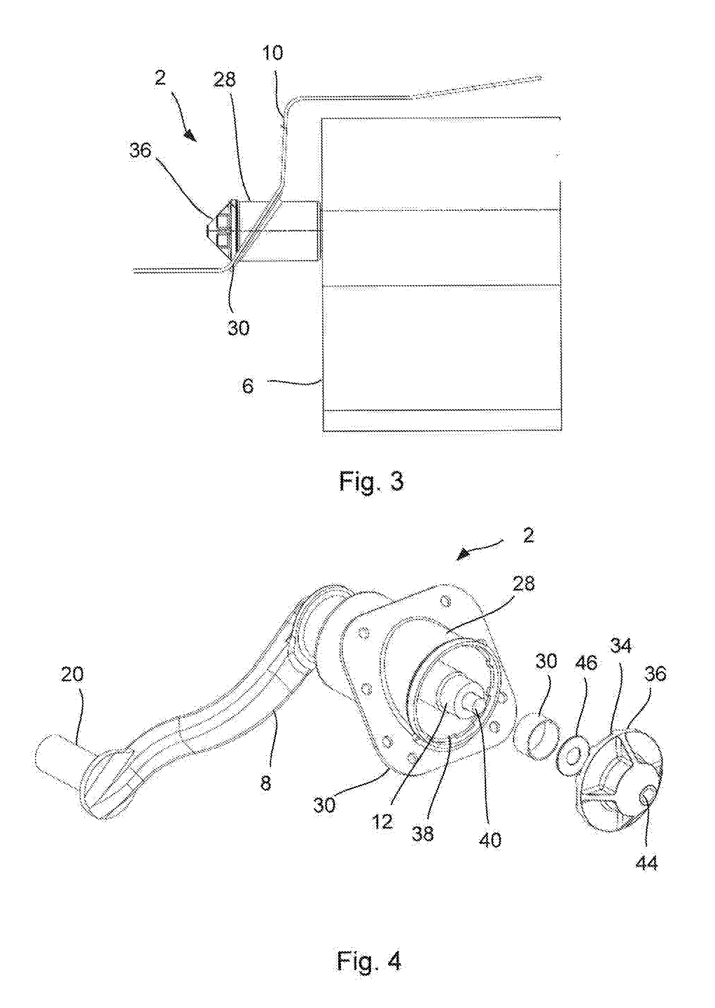

The outer bushing sleeve 16 is supported by a support housing 28 with a fastening flange 30 for suspension of the entire suspension system 2 in the side of the vehicle chassis 10. From FIG. 3 is apparent in a side view how the support housing 28 is fixed in the side of the vehicle chassis 10 with the help of the fastening flange 30. The support housing 28 is mounted in an opening in the side 10 of the vehicle chassis 10, such that access of the inside of the support housing 28 may be effected both from the inside and the outside of the vehicle 1.

From FIG. 2 is apparent that the outer bushing sleeve 16 is provided with a pivot preventing means in the shape of a number of axially directed tongues 32 for pivot preventing locking engagement with corresponding protrusions 34 in a gable 36 interacting with the support housing 28 or vice versa. The gable 36 according to the first embodiment thus constitutes a separate unit.

FIG. 4 shows a perspective view of the suspension system 2 for a tracked vehicle 1 according to the first embodiment. From FIG. 4 is apparent that the inside of the support housing 28 is provided with a pivot preventing means in the shape of a number of circumferential recesses 38 for pivot preventing locking engagement with the protrusions 34 in the gable 36 or vice versa. For clarifying purpose the rubber bushing 14 and the inner and outer bushing sleeves 24, 16 have been left out in FIG. 2. The tongues 32, the recesses 38 and the protrusions 34 interact to prevent the outer bushing sleeve 16 to be turned in the in the support housing 28. The outer bushing sleeve 16 may during assembly in the support housing 28 be placed in suitable engagement with the recesses 38 and protrusions 38, such that the rocker arm 8 ends up in a correct position relative to the vehicle 1. When a torque arises in the pivot axle 12 the torque acts on the inner bushing sleeve 24 via the first splined joint 26. Thereafter the torque is taken up by the spring acting and damping rubber bushing 14 via the vulcanization joint between the rubber bushing 14 and the inner bushing sleeve 24. The torque is transferred further to the outer bushing sleeve 16 through the vulcanization joint between the rubber bushing 14 and the outer bushing sleeve 16. At last the torque is taken up by the, to the vehicle chassis connected, support housing 28 via the tongues 32 in the outer bushing sleeve 16, the protrusions 34 in the gable and the recesses 38 in the support housing 28.

A hinged lock pin 40 is arranged to extend coaxially through the pivot axle 12 so as to axially fixate the rubber bushing 14 and associated components in the support housing 28. The lock pin 40 bears with its head 42 on one end surface of the pivot axle 12 and is fixedly screwed in a hinged hole 44 in the gable 36. It also shows that axial bearings 46 are arranged at the end surfaces of the pivot axle 12, such that the pivot axle 12 is axially journalled to the lock pin 40 and the gable 36. By releasing the lock pin 40 the rubber bushing 14 and bearings 18, 46 may easily be replaced during service and maintenance of the suspension system 2.

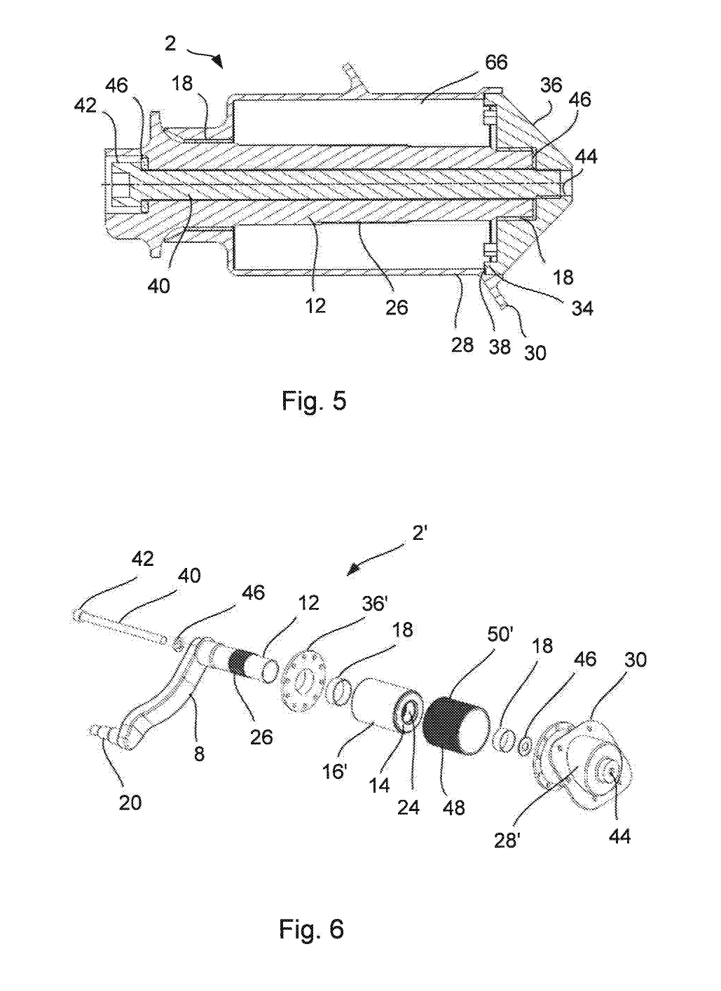

FIG. 5 shows a cross sectional view through the suspension system 2 for a tracked vehicle 1 according to the first embodiment of the invention. The pivot axle 12 is journalled by means of radial bearing 18 in the support housing 28 and in the gable 36. For clarifying purposes the rubber bushing 14 and the inner and outer bushing sleeves 24, 16 have been left out in FIG. 5. The radial bearings 18 are arranged on each side of the space in the support housing 28 where the rubber bushing 14 is to be housed, such that the rubber bushing 14 only takes up torsional forces. Thereby the rubber bushing 14 will be relieved from large side forces, which results in that the pivot axle 12 of the rocker arm 8 and the centre axel of the rubber bushing 14 will be remain essentially parallel. Thus it is avoided that the rubber bushing 14 will be tilted relative to the rocker arm 8. As a result the rubber material in the rubber bushing 14 will not be permanently deformed. Thereby correct camber angle of the support wheel 4 will be maintainable.

FIG. 6 shows a perspective view of the suspension system 2′ for a tracked vehicle 1 according to a second embodiment of the present invention. According to the second embodiment the outer bushing sleeve 16′ is rotationally fixed in the support housing 28′ with a pivot preventing means in the shape of a second splined joint 48. The outer bushing sleeve 16′ is enclosed by and is rotationally fixed to an outer sleeve 50′, which is provided with splines for the second splined joint 48. The rubber bushing 14 is arranged on the pivot axle 12 by means of the inner bushing sleeve 24 and rotationally fixed on the pivot axle 12 by means of the first splined joint 26.

Preferably the outer bushing sleeve 16′ is pressed into the outer sleeve. The gable 36′ is mounted with a bolt joint on the support housing 28′. A lock pin 40 is arranged to extend coaxially through the pivot axle 12 so as to axially fixate the rubber bushing 14 and associated components in the support housing 28′. The outer support sleeve 16′ may during mounting in the support housing 28′ be placed with the second splined joint 48, such that the rocker arm 8 ends up in correct position relative to the vehicle 1. It is also apparent that axial bearings 46 are arranged at the end surfaces of the pivot axle 12, such that the pivot axle 12 is axially journalled to the lock pin 40 and the support housing 28′. The pivot axle 12 is journalled by means of radial bearings 18 in the shape of slide bearings in the support housing 28′ and the gable 36′, which radial bearings 18 are arranged on each side of the rubber bushing 14, such that the rubber bushing 14 takes up only torsional forces.

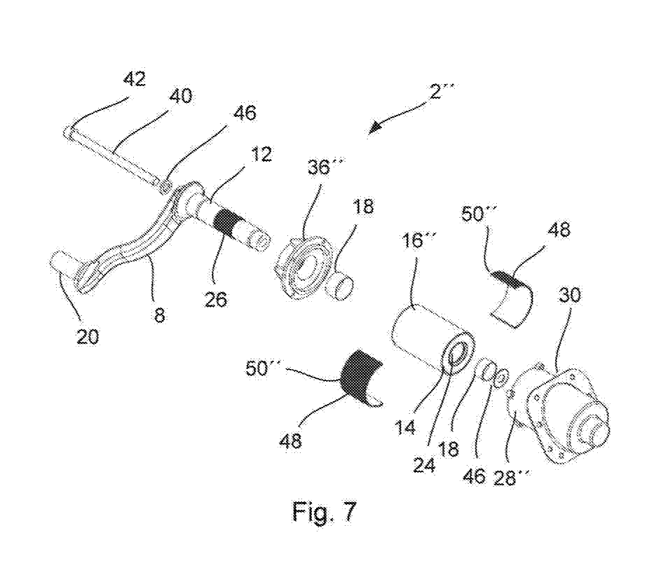

FIG. 7 shows a perspective view of the suspension system 2″ for a tracked vehicle 1 according to a third embodiment of the present invention. According to the third embodiment the outer sleeve 50″ is divisibly arranged on the outer bushing sleeve 16″ by a glue joint. Preferably the inner bushing sleeve 24 is arranged on the pivot axle 12 via a first splined joint 26. The outer sleeve 50′ is provided with splines for the second splined joint 48, which twist-fast connects the outer sleeve 50′ and thereby the rubber bushing 14 to the support housing 28″. In a similar way as for the second embodiment the gable 36″ is mounted with a pin joint on the support housing 28″. A hinged lock pin 40 is arranged to extend coaxially through the pivot axle 12 so as to axially fixate the rubber bushing 14 and other associated components in the support housing 28″. It is also apparent that axial bearings 46 are arranged at the end surfaces of the pivot axle 12, such that the pivot axle 12 is axially journalled to the lock pin 40 and the support housing 28″. The pivot axle 12 is journalled by means of radial bearings 18 in the shape of slide bearings in the support housing 28″ and in the gable 36″, which radial bearings 18 are arranged on each side of the rubber bushing 14, such that the rubber bushing 14 takes up only torsional forces.

Specified components and features given above may within the scope of the invention be combined between different specified embodiments.

1. A suspension system for a tracked vehicle, comprising support wheels arranged on opposite sides of the vehicle for contact against the inside of a respective endless drive track, the support wheels being rotatably journalled at an outer end of a respective rocker arm, which at its inner end to a limited extent is pivotably journalled in the side of a vehicle chassis of the vehicle, which rocker arm comprises a pivot axle, which extends transversely to the longitudinal extension of the vehicle, wherein a torsion element in the shape of a rubber bushing is rotationally fixed to the pivot axle and which rubber bushing is enclosed by and fixedly connected to an outer bushing sleeve arranged to be fixedly fastened in the side of the vehicle chassis, wherein the pivot axle is pivotably journalled in the vehicle chassis with radial bearings arranged on each side of the rubber bushing, such that the rubber bushing takes up only torsional forces, wherein
the outer bushing sleeve is supported by a support housing with a fastening flange for suspension of the entire suspension system (2; 2′; 2″) in the side of the vehicle chassis, and
the outer bushing sleeve and the support housing comprises a pivot preventing means member interacting with each other so as to prevent the outer bushing sleeve to be pivoted relative to the support housing, as well as to place the rocker arm in correct position relative to the vehicle.

2. A suspension system according to claim 1, wherein the radial bearings are slide bearings.

3. A suspension system according to claim 1, wherein the rubber bushing encloses and is fixedly connected to an inner bushing sleeve, which is twist-fast arranged on the pivot axle with a first splined joint.

4. A suspension system according to claim 3, wherein the rubber bushing is fixedly vulcanized in the outer bushing sleeve and on the inner bushing sleeve.

5. A suspension system according to claim 1, wherein the pivot preventing member comprises a number of axially arranged tongues arranged on the outer bushing sleeve for pivot preventing locking engagement with corresponding protrusions in a gable interacting with the support housing or vice versa.

6. A suspension system according to claim 5, wherein the pivot preventing member comprises a number of circumferential recesses on the support housing for pivot preventing locking engagement with the protrusions in the gable or vice versa.

7. A suspension system according to claim 1, wherein the outer bushing sleeve is rotationally fixed in the support housing with the pivot preventing member in the shape of a second splined joint.

8. A suspension system according to claim 1, wherein the outer bushing sleeve is rotationally fixed to an outer sleeve, which is provided with the pivot preventing member in the shape of splines for the second splined joint.

9. A suspension system according to claim 7, wherein a lock pin is arranged to extend coaxially through the pivot axle so as to axially fixate the rubber bushing in the support housing.

10. A suspension system according to claim 9, wherein axial bearings are arranged at the end surfaces of the pivot axle, such that the pivot axle is journalled to the lock pin and the support housing or the gable.
